(19) United States
(12) Patent Application Publication
(10) Pub. No.: US 2025/0303306 A1
(43) Pub. Date: Oct. 2, 2025

(54) GAME PLAY MATCHMAKING

(71) Applicant: Electronic Arts Inc., Redwood City, CA (US)

(72) Inventors: Laura Greige, San Francisco, CA (US); Fernando de Mesentier Silva, New York City, NY (US)

(21) Appl. No.: 18/621,560

(22) Filed: Mar. 29, 2024

(51) Int. Cl. A63F 13/795; A63F 13/798

(52) U.S. Cl. CPC A63F 13/795; A63F 13/798

(57) ABSTRACT

A method for matchmaking of game players includes receiving player data associated with a user account, receiving match state data associated with a match of the game, and based on the player data and the match state data, extracting engagement prediction features. The method further includes providing, as an input to an engagement prediction model, the engagement prediction features, and receiving, as an output from the engagement prediction model, a predicted engagement metric, the predicted engagement metric being based on the engagement prediction features. The method further includes providing the predicted engagement metric as an input to a matchmaking system and receiving from the matchmaking system a decision whether to match the user account to the match of the game for gameplay.

### TECHNICAL FIELD

The present disclosure generally relates to improving the experience of players who are playing games, and more particularly to improving matchmaking between game players.

### BACKGROUND

Multi-player games often have matchmaking systems that pair players with each other during the game, as opponents or teammates, into selected game scenarios. Matchmaking systems account for the match state of the game but are not able to account for user-specific criteria that affect a user's engagement with the game. However, if a player is matched to other players and/or game scenarios that they find undesirable, they are less likely to keep playing the game.

For example, there may be match states that end up being undesirable for many if not most players. In a capture-the-flag type of scenario, if there is considerable domination by one team over the other, many players that join the match after that point quit quickly, regardless of whether they joined the team that is dominating or being dominated. Players are less likely to leave a match if they joined at the very beginning, compared to players who have joined after the match was already in progress.

As such, there is a need for more personalized matchmaking to improve enjoyment of the player and increase their engagement with the game.

### SUMMARY

Some embodiments of the present disclosure provide a method for matchmaking of game players. The method includes receiving player data associated with a user account, receiving match state data associated with a match of the game, and based on the player data and the match state data, extracting engagement prediction features. The method further includes providing as an input to an engagement prediction model the engagement prediction features, receiving as an output from the engagement prediction model a predicted engagement metric that is based on the engagement prediction features, providing the predicted engagement metric as an input to a matchmaking system, and receiving from the matchmaking system a decision whether to match the user account to the match of the game for gameplay.

Some embodiments of the present disclosure provide a non-transitory computer readable medium that stores a program for matchmaking of game players, which when executed by a computer, configures the computer to a receive player data associated with a user account, receive match state data associated with a match of the game, and based on the player data and the match state data, extract engagement prediction features. The program, when executed, further configures the computer to provide as an input to an engagement prediction model the engagement prediction features, receive as an output from the engagement prediction model a predicted engagement metric that is based on the engagement prediction features, provide the predicted engagement metric as an input to a matchmaking system, and receive from the matchmaking system a decision whether to match the user account to the match of the game for gameplay. In some embodiments, the player data includes gameplay history data, player engagement history data, and player-specific attribute data.

Some embodiments of the present disclosure provide a system for matchmaking of game players. The system includes a processor and a non-transitory computer readable medium storing a set of instructions, which when executed by the processor, configure the processor to receive player data associated with a user account, receive match state data associated with a match of the game, and based on the player data and the match state data, extract engagement prediction features. The instructions when executed further configure the processor to provide as an input to an engagement prediction model the engagement prediction features, receive as an output from the engagement prediction model a predicted engagement metric that is based on the engagement prediction features, provide the predicted engagement metric as an input to a matchmaking system, and receive from the matchmaking system a decision whether to match the user account to the match of the game for gameplay.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments.

FIG. 1 illustrates a network architecture used to implement matchmaking in games, according to some embodiments.

FIG. 2 is a block diagram illustrating details of a system for matchmaking in games, according to some embodiments.

FIG. 3 is a flowchart illustrating a process 300 for matchmaking in games performed by a client device (e.g., client device 110, etc.) and/or a client server (e.g., server 130, etc.), according to some embodiments.

FIG. 4 shows a block diagram of a system for matchmaking of game players.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

Embodiments of the present disclosure enhance matchmaking in games by training a model to predict player engagement and using player engagement as an additional input to the matchmaking process.

The term “user account” as used herein refers, according to some embodiments, an object created for an entity (e.g., the “user”), such as but not limited to a human being, software service, or computer. The user account enables access to resources, login capabilities, and resource access based on permissions. User accounts play a role in authentication and authorization processes, where authentication verifies a user's identity through methods like usernames, passwords, security keys, one-time passwords, biometrics, and the like, while authorization determines the level of access a user has based on their role. The term “user account” may be equivalently referred to herein as “player,” “user,” or “account.”

The term “matchmaking” as used herein refers, according to some embodiments, to a process for connecting players together for online play sessions based on various factors. Matchmaking aims to pair players to keep games competitive and engaging while minimizing delays caused by distant connections. By analyzing these factors and adjusting match configurations, matchmaking systems enhance player satisfaction and overall gameplay quality. Matchmaking systems may use data such as a number of available slots in a match, rematching rates, a user's matchmaking rating (MMR), a user's skill level, skill balance within a match, skill balance within a team, geographical location, latency, joining as a group, and playing as a group as part of the matchmaking process.

The term “engagement” as used herein refers, according to some embodiments, to the length of time that a player is likely to play a game. Player engagement may also be represented by a score, for example, as a probability or a likelihood that the player will continue to play the game.

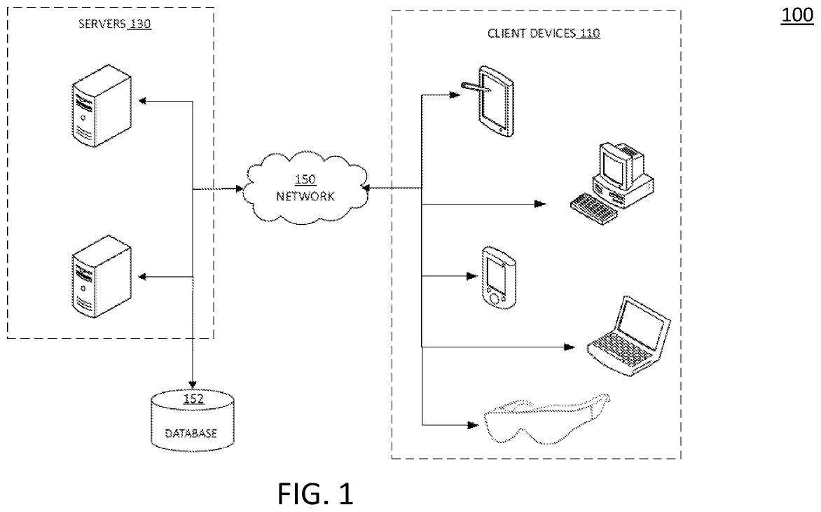

FIG. 1 illustrates a network architecture 100 used to implement matchmaking of game players, according to some embodiments. The network architecture 100 may include servers 130 and a database 152, communicatively coupled with multiple client devices 110 via a network 150. Client devices 110 may include, but are not limited to, laptop computers, desktop computers, and the like, and/or mobile devices such as smart phones, palm devices, video players, headsets, tablet devices, and the like.

The network 150 may include, for example, any one or more of a local area network (LAN), a wide area network (WAN), the Internet, and the like. Further, the network 150 may include, but is not limited to, any one or more of the following network topologies, including a bus network, a star network, a ring network, a mesh network, a star-bus network, tree or hierarchical network, and the like.

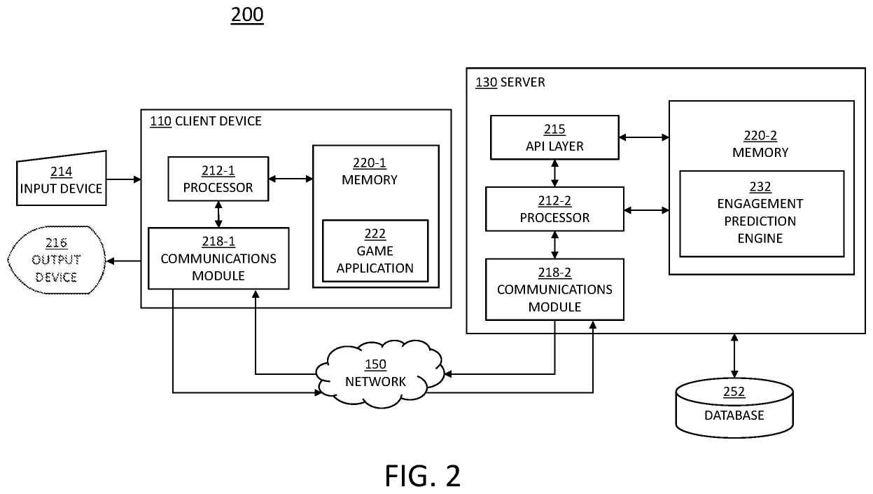

FIG. 2 is a block diagram illustrating details of a system 200 for matchmaking of game players having at least one of client device 110, at least one of server 130, and a network architecture 100 as disclosed herein, according to some embodiments. Client device 110 and server 130 are communicatively coupled over network 150 via respective communications modules 218-1 and 218-2 (hereinafter, collectively referred to as “communications modules 218”). Communications modules 218 are configured to interface with network 150 to send and receive information, such as requests, uploads, messages, and commands to other devices on the network 150. Communications modules 218 can be, for example, modems or Ethernet cards, and may include radio hardware and software for wireless communications (e.g., via electromagnetic radiation, such as radiofrequency (RF), near field communications (NFC), Wi-Fi, and Bluetooth radio technology). Client device 110 may be coupled with an input device 214 and with an output device 216. A user may interact with client device 110 via the input device 214 and the output device 216. Input device 214 may include a mouse, a keyboard, a pointer, a touchscreen, a microphone, a joystick, a virtual joystick, a touch-screen display that a user may use to interact with client device 110, or the like. In some embodiments, input device 214 may include cameras, microphones, and sensors, such as touch sensors, acoustic sensors, inertial motion units and other sensors configured to provide input data to a VR/AR headset. Output device 216 may be a screen display, a touchscreen, a speaker, and the like.

Client device 110 may also include a processor 212-1, configured to execute instructions stored in a memory 220-1, and to cause the client device 110 to perform at least some operations in methods consistent with the present disclosure. Memory 220-1 may further include a game application 222, configured to run in client device 110 and couple with input device 214 and output device 216. The game application 222 may be downloaded by the user from server 130, and/or may be hosted by server 130. The game application 222 includes specific instructions which, when executed by processor 212-1, cause operations to be performed according to methods described herein. In some embodiments, the game application 222 runs on an operating system (OS) installed in client device 110. In some embodiments, game application 222 may run within a web browser. In some embodiments, the processor 212-1 is configured to control a graphical user interface (GUI) for the user of one of client devices 110 accessing the server 130.

Database 252 may store data and files associated with the server 130 from the game application 222. In some embodiments, client device 110 collects data, including but not limited to video and images, for upload to server 130 using game application 222, to store in the database 252.

Server 130 includes a memory 220-2, a processor 212-2, and communications module 218-2. Processor 212-2 may communicate with memory 220-2 directly or through an API layer 215. Hereinafter, processors 212-1 and 212-2, and memories 220-1 and 220-2, will be collectively referred to, respectively, as “processors 212” and “memories 220.” Processors 212 are configured to execute instructions stored in memories 220. In some embodiments, memory 220-2 includes an engagement prediction engine 232. The engagement prediction engine 232 may be configured to perform operations and methods according to aspects of embodiments. The engagement prediction engine 232 may share or provide features and resources with the client device, including multiple tools associated with data, image, video collection, capture, or applications that use data, images, or video retrieved with engagement prediction engine 232 (e.g., game application 222). The user may access the engagement prediction engine 232 through the game application 222, installed in a memory 220-1 of client device 110. Accordingly, game application 222 may be installed by server 130 and perform scripts and other routines provided by server 130 through any one of multiple tools. Execution of game application 222 may be controlled by processor 212-1.

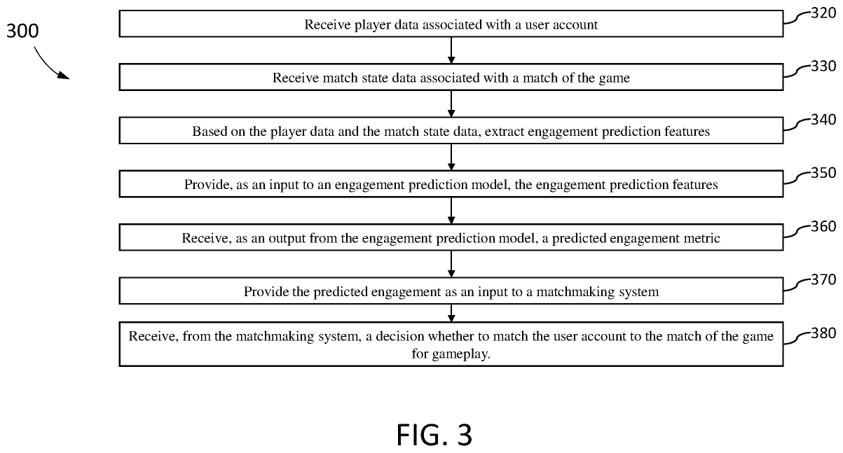

FIG. 3 is a flowchart illustrating a process 300 for matchmaking of game players performed by a client device (e.g., client device 110, etc.) and/or a client server (e.g., server 130, etc.), according to some embodiments. In some embodiments, one or more operations in process 300 may be performed by a processor circuit (e.g., processors 212, etc.) executing instructions stored in a memory circuit (e.g., memories 220, etc.) of a system (e.g., system 200, etc.) as disclosed herein. For example, operations in process 300 may be performed by gaming application 222, engagement prediction engine 232, or some combination thereof. Moreover, in some embodiments, a process consistent with this disclosure may include at least operations in process 300 performed in a different order, simultaneously, quasi-simultaneously, or overlapping in time.

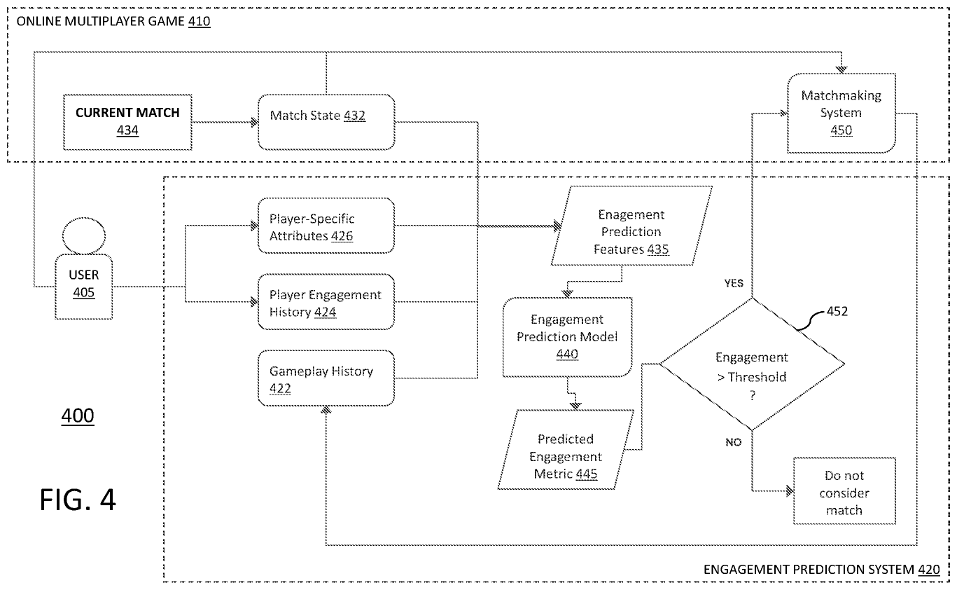

The process 300 will be discussed with reference to an exemplary example shown in FIG. 4, which shows a block diagram of a system 400 (e.g., system 200) for matchmaking of game players. Various elements of system 400 may perform or execute operations of process 300, as described in further detail below. In this non-limiting example, the system 400 includes a user account 405 waiting to be matched while playing an online game 410, that has in-progress sessions (equivalently referred to herein as “matches” or “online matches”) or pending sessions about to begin. The game 410 may be, but is not limited to, an adversarial game or a cooperative game. The game 410 may be, but is not limited to, a single player game or a multiplayer game. The system 400 also includes an engagement prediction system 420, which is described in further detail below. For example, the process 300 may be performed by the engagement prediction system 420 in some embodiments.

In some embodiments, the user account 405 may be waiting in an ordered queue or may be in a pool of users. To play the game, the user account 405 needs to be matched to other players, to begin a new match, or backfill an existing ongoing match. The user account (or an avatar, character, etc. representing the user account 405) may, for example, be placed in a waiting area or lobby while waiting to be matched.

At 320, the process 300 receives player data associated with a user account. For example, as shown in FIG. 4, in some embodiments, the player data includes gameplay history 422, player engagement history 424, and player-specific attributes 426. The player data may be generated by the player's actions in game, and/or by compiling data from external sources (e.g., a social graph of the user account), or some combination thereof.

The player-specific attributes 426 may include, but are not limited to, player preferences, skill, playstyle, toxicity level, average kills and deaths in a session, winning streak, hours played in current session, hours played total, joining as a group, playing as a group, friend connections, and any combination thereof. The player preferences (which are not shown in FIG. 4, but in this example are a subset of player-specific attributes 426) may include, but are not limited to, game map preferences, weapon preferences, vehicle preferences, character class preferences, game settings, and any combination thereof.

The player engagement history 424 may be a history of the player's engagement during previous playing sessions of the game 410. In some embodiments, player engagement history 424 may be represented as a length of time playing the game 410, for different types of play sessions, game maps, and other game configurations and options.

The gameplay history 422 may include, but is not limited to, days since first session date, engagement rate in recent weeks, engagement rate in recent days, leave/quit ratio in recent weeks, leave/quit ratio in recent days, time of day, day of week, total amount spent, transaction history, match history, and any combination thereof.

In FIG. 4, the player-specific attributes 426, the player engagement history 424, and/or the gameplay history 422 are shown as being provided from the user account 405, indicating that this data originates from user actions or external sources associated with the user account 405. However, in some embodiments, the player-specific attributes 426, the player engagement history 424, and/or the gameplay history 422 may be alternatively or additionally provided directly from the game 410.

At 330, the process 300 receives match state data (e.g., match state 432) associated with a match of the game. In the example of FIG. 4, the match state 432 includes, but is not limited to, a game map, a match capacity of the game, a number of players currently playing the game, a number of artificial intelligence bots playing the game, current scores in the game, progress of the game, number of objectives completed in the game, and any combination thereof. The match state 432 defines the current match 434 under consideration for user account 405.

At 340, the process 300 extracts engagement prediction features (e.g., engagement prediction features 435) based on the player data and the match state data. The process 300 provides (at 350) the engagement prediction features as an input to an engagement prediction model (e.g., engagement prediction model 440). In some embodiments, the engagement prediction model is trained on features extracted from player data and match state data from a cohort of previous match decisions.

At 360, the process 300 receives, as an output from the engagement prediction model, a predicted engagement metric (e.g., predicted engagement metric 445) based on the input. The engagement metric predicts, for a given match defined by the match state, how likely the user account is to stay engaged with the game.

In some embodiments, the predicted engagement metric may be generated at any point in time, as many times as needed. A separate predicted engagement metric may be generated from the engagement prediction model for multiple players and all combination of possible matches to decide the best option for matchmaking.

Some embodiments consider all possible matches, feeding all the possible match combinations into the model for every waiting user account. Some embodiments prune the possible match combinations based on various factors, such as latency and other geographic and cultural factors.

In some embodiments, changes in the match state may lead to changes in the prediction, though some changes may be small to the point of little to no impact on the prediction. Accordingly, some embodiments run the prediction as close to the moment when the system is making the decision as possible.

In the example of FIG. 4, the predicted engagement metric 445 is an engagement score that represents a likelihood that the user account 405 will engage in the current match 434 defined by the match state 432. For example, the score may have a range from 0.0 (representing no engagement) to 1.0 (maximum engagement).

At 370, the process 300 provides the predicted engagement metric as an input to a matchmaking system (e.g., matchmaking system 450 of game 410). The matchmaking system may be any matchmaking system that is part of or compatible with the online game.

In some embodiments, the predicted engagement metric may be filtered to prevent low-quality matches from being considered at all by the matchmaking system. As an example, the engagement prediction system 420 of FIG. 4 determines (e.g., in a filtering module 452) whether the predicted engagement metric 445 is greater than a pre-defined engagement threshold associated with the match state 432. The engagement threshold may be for a new potential match or for a backfill of an ongoing match. In some embodiments, the engagement threshold may be a global value, but the engagement prediction may be player specific, so from a group of potential ongoing and new matches, the potential engagement of any particular player would vary. As shown in FIG. 4, if the predicted engagement metric 445 is greater than the engagement threshold, then the engagement prediction system 420 provides the engagement metric to the matchmaking system 450 of the game 410. If the predicted engagement metric 445 is below the engagement threshold, then the engagement metric is not provided to the matchmaking system 450. The engagement threshold may be determined, for example, by game designers or administrators, to preferentially favor matches that they consider to be viable for game mechanics reasons, business reasons, and the like.

In some embodiments, any or all of the match state 432, the predicted engagement metric 445, and the engagement threshold may be partially defined by the scale of the online match. For example, for a 1v1 match (equivalently referred to as one-versus-one matches), which is a gameplay scenario where two individual players compete directly against each other, the match state 432 may be static for every possible match, and the match state would only be considered in the “potential match” state (e.g., no backfilling). In that case, the match state 432 may be a combination of the opponent's player-specific attributes and match factors like map or game mode. For a large scale match, with numerous players and where a potential match may be to backfill an ongoing online match, then the match state 432 may prioritize features like the number of current players in the match, current match score, etc.

At 380, the process 300 receives from the matchmaking system a decision whether to match the user account to the match of the game for gameplay. In some embodiments, the match state data may also be provided as an input to the matchmaking system, and the decision depends on both the match state data and the predicted engagement metric. In some embodiments, the matchmaking system may reject a match even if the predicted engagement metric is above the threshold.

In the example of FIG. 4, the decision (not shown in FIG. 4) by the matchmaking system 450 may be used to update the gameplay history 422 and/or the player engagement history 424 with the match results. In this manner, each match decision is used for continuous learning of the engagement prediction system 420, by keeping the engagement prediction features 435 fresh and up to date, either with regular or scheduled updates or in real time.

Many of the above-described features and applications may be implemented as software processes that are specified as a set of instructions recorded on a computer readable storage medium (alternatively referred to as computer readable media, machine-readable media, or machine-readable storage media). When these instructions are executed by one or more processing unit(s) (e.g., one or more processors, cores of processors, or other processing units), they cause the processing unit(s) to perform the actions indicated in the instructions. Examples of computer readable media include, but are not limited to, RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ultra-density optical discs, any other optical or magnetic media, and floppy disks. In one or more embodiments, the computer readable media does not include carrier waves and electronic signals passing wirelessly or over wired connections, or any other ephemeral signals. For example, the computer readable media may be entirely restricted to tangible, physical objects that store information in a form that is readable by a computer. In one or more embodiments, the computer readable media is non-transitory computer readable media, computer readable storage media, or non-transitory computer readable storage media.

In one or more embodiments, a computer program product (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

While the above discussion primarily refers to microprocessor or multi-core processors that execute software, one or more embodiments are performed by one or more integrated circuits, such as application specific integrated circuits (ASICs) or field programmable gate arrays (FPGAs). In one or more embodiments, such integrated circuits execute instructions that are stored on the circuit itself.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way), all without departing from the scope of the subject technology.

It is understood that any specific order or hierarchy of blocks in the processes disclosed is an illustration of example approaches. Based upon implementation preferences, it is understood that the specific order or hierarchy of blocks in the processes may be rearranged, or that not all illustrated blocks be performed. Any of the blocks may be performed simultaneously. In one or more embodiments, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The subject technology is illustrated, for example, according to various aspects described above. The present disclosure is provided to enable any person skilled in the art to practice the various aspects described herein. The disclosure provides various examples of the subject technology, and the subject technology is not limited to these examples. Various modifications to these aspects will be readily apparent to those skilled in the art, and the generic principles defined herein may be applied to other aspects.

A reference to an element in the singular is not intended to mean “one and only one” unless specifically stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the disclosure.

To the extent that the terms “include,” “have,” or the like is used in the description or the claims, such term is intended to be inclusive in a manner similar to the term “comprise” as “comprise” is interpreted when employed as a transitional word in a claim.

The word “exemplary” is used herein to mean “serving as an example, instance, or illustration.” Any embodiment described herein as “exemplary” is not necessarily to be construed as preferred or advantageous over other embodiments. In one aspect, various alternative configurations and operations described herein may be considered to be at least equivalent.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a configuration may refer to one or more configurations and vice versa.

In one aspect, unless otherwise stated, all measurements, values, ratings, positions, magnitudes, sizes, and other specifications that are set forth in this specification, including in the claims that follow, are approximate, not exact. In one aspect, they are intended to have a reasonable range that is consistent with the functions to which they relate and with what is customary in the art to which they pertain. It is understood that some or all steps, operations, or processes may be performed automatically, without the intervention of a user.

Method claims may be provided to present elements of the various steps, operations, or processes in a sample order, and are not meant to be limited to the specific order or hierarchy presented.

In one aspect, a method may be an operation, an instruction, or a function and vice versa. In one aspect, a claim may be amended to include some or all of the words (e.g., instructions, operations, functions, or components) recited in other one or more claims, one or more words, one or more sentences, one or more phrases, one or more paragraphs, and/or one or more claims.

All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

The Title, Background, and Brief Description of the Drawings of the disclosure are hereby incorporated into the disclosure and are provided as illustrative examples of the disclosure, not as restrictive descriptions. It is submitted with the understanding that they will not be used to limit the scope or meaning of the claims. In addition, in the Detailed Description, it can be seen that the description provides illustrative examples, and the various features are grouped together in various embodiments for the purpose of streamlining the disclosure. This method of disclosure is not to be interpreted as reflecting an intention that the included subject matter requires more features than are expressly recited in any claim. Rather, as the claims reflect, inventive subject matter lies in less than all features of a single disclosed configuration or operation. The claims are hereby incorporated into the Detailed Description, with each claim standing on its own to represent separately patentable subject matter.

The claims are not intended to be limited to the aspects described herein but are to be accorded the full scope consistent with the language of the claims and to encompass all legal equivalents. Notwithstanding, none of the claims are intended to embrace subject matter that fails to satisfy the requirement of 35 U.S.C. § 101, 102, or 103, nor should they be interpreted in such a way.

It should be understood that the original applicant herein determines which technologies to use and/or productize based on their usefulness and relevance in a constantly evolving field, and what is best for it and its players and users. Accordingly, it may be the case that the systems and methods described herein have not yet been and/or will not later be used and/or productized by the original applicant. It should also be understood that implementation and use, if any, by the original applicant, of the systems and methods described herein are performed in accordance with its privacy policies. These policies are intended to respect and prioritize player privacy, and to meet or exceed government and legal requirements of respective jurisdictions. To the extent that such an implementation or use of these systems and methods enables or requires processing of user personal information, such processing is performed (i) as outlined in the privacy policies; (ii) pursuant to a valid legal mechanism, including but not limited to providing adequate notice or where required, obtaining the consent of the respective user; and (iii) in accordance with the player or user's privacy settings or preferences. It should also be understood that the original applicant intends that the systems and methods described herein, if implemented or used by other entities, be in compliance with privacy policies and practices that are consistent with its objective to respect players and user privacy.

Embodiments consistent with the present disclosure may be combined with any combination of features or aspects of embodiments described herein.

1. A method for matchmaking of game players, comprising:
receiving player data associated with a user account;
receiving match state data associated with a match of the game;
based on the player data and the match state data, extracting a plurality of engagement prediction features;
providing, as an input to an engagement prediction model, the plurality of engagement prediction features;
receiving, as an output from the engagement prediction model, a predicted engagement metric, the predicted engagement metric being based on the plurality of engagement prediction features;
providing the predicted engagement metric as an input to a matchmaking system; and
receiving from the matchmaking system a decision whether to match the user account to the match of the game for gameplay.

2. The method of claim 1, wherein the match state data comprises at least one of a game map, a match capacity of the game, a number of players currently playing the game, current scores in the game, progress of the game, and number of objectives completed in the game.

3. The method of claim 1, wherein the player data comprises gameplay history data, player engagement history data, and player-specific attribute data.

4. The method of claim 3, wherein the player-specific attribute data comprises at least one of player preferences, skill, playstyle, toxicity level, average kills and deaths in a session, winning streak, hours played in current session, hours played total, joining as a group, playing as a group, and friend connections.

5. The method of claim 4, wherein the player preferences comprise at least one of game map preferences, weapon preferences, vehicle preferences, and character class preferences.

6. The method of claim 1, wherein the user account is matched to a match of the game that includes one or more other matched accounts.

7. The method of claim 1, wherein the predicted engagement comprises an engagement score that represents a likelihood that the user account will engage in a match defined by the match state data.

8. The method of claim 7, wherein the engagement score is a value between zero and one, inclusive, with a minimum value of zero representing a first prediction that the user account will not engage, and a maximum value of one representing a second prediction that the user account will engage.

9. The method of claim 7, wherein providing the predicted engagement as an input to a matchmaking system is based on a determination that the engagement score is greater than a pre-defined engagement threshold associated with the match state data, wherein proposed matches with engagement scores below the pre-defined engagement threshold are not provided to the matchmaking system.

10. The method of claim 1, further comprising providing the match state data as a further input to the matchmaking system.

11. A non-transitory computer readable medium storing a program for matchmaking of game players, which when executed by a computer, configures the computer to:
receive player data associated with a user account;
receive match state data associated with a match of the game;
based on the player data and the match state data, extract a plurality of engagement prediction features;
provide, as an input to an engagement prediction model, the plurality of engagement prediction features;
receive, as an output from the engagement prediction model, a predicted engagement metric, the predicted engagement metric being based on the plurality of engagement prediction features;
provide the predicted engagement metric as an input to a matchmaking system; and
receive from the matchmaking system a decision whether to match the user account to the match of the game for gameplay,
wherein the player data comprises gameplay history data, player engagement history data, and player-specific attribute data.

12. The non-transitory computer readable medium of claim 11, wherein the match state data comprises at least one of a game map, a match capacity of the game, a number of players currently playing the game, a number of artificial intelligence bots playing the game, current scores in the game, progress of the game, and number of objectives completed in the game.

13. The non-transitory computer readable medium of claim 11, wherein the player-specific attribute data comprises at least one of player preferences, skill, playstyle, toxicity level, average kills and deaths in a session, winning streak, hours played in current session, hours played total, joining as a group, playing as a group, and friend connections.

14. The non-transitory computer readable medium of claim 13, wherein the player preferences comprise at least one of game map preferences, weapon preferences, vehicle preferences, and character class preferences.

15. The non-transitory computer readable medium of claim 1, wherein the user account is matched to a match of the game that includes one or more other matched accounts.

16. The non-transitory computer readable medium of claim 11, wherein the predicted engagement comprises an engagement score that represents a likelihood that the user account will engage in a match defined by the match state data.

17. The non-transitory computer readable medium of claim 16, wherein the engagement score is a value between zero and one, inclusive, with a minimum value of zero representing a first prediction that the user account will not engage, and a maximum value of one representing a second prediction that the user account will engage.

18. The non-transitory computer readable medium of claim 16, wherein providing the predicted engagement as an input to a matchmaking system is based on a determination that the engagement score is greater than a pre-defined engagement threshold associated with the match state data, wherein proposed matches with engagement scores below the pre-defined engagement threshold are not provided to the matchmaking system.

19. The non-transitory computer readable medium of claim 11, wherein the program, when executed by the computer, further configures the computer to provide the match state data as a further input to the matchmaking system.

20. A system for matchmaking of game players, comprising:
a processor; and
a non-transitory computer readable medium storing a set of instructions, which when executed by the processor, configure the processor to:
receive player data associated with a user account;
receive match state data associated with a match of the game;
based on the player data and the match state data, extract a plurality of engagement prediction features;
provide, as an input to an engagement prediction model, the plurality of engagement prediction features;
receive, as an output from the engagement prediction model, a predicted engagement metric, the predicted engagement metric being based on the plurality of engagement prediction features;
provide the predicted engagement metric as an input to a matchmaking system; and
receive from the matchmaking system a decision whether to match the user account to the match of the game for gameplay.
